(19) United States
(12) Patent Application Publication
(10) Pub. No.: US 2010/0269142 A1
(43) Pub. Date: Oct. 21, 2010

(54) UTILITY OPTIMIZATION FOR SCALABLE VIDEO MULTICAST IN WIRELESS SYSTEMS

(75) Inventors: Peilong Li, Hefei (CN); Honghai Zhang, Ewing, NJ (US); Sampath Rangarajan, Bridgewater, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/696,703

(22) Filed: Jan. 29, 2010

Related U.S. Application Data
(60) Provisional application No. 61/169,870, filed on Apr. 16, 2009.
(60) Provisional application No. 61/239,854, filed on Sep. 4, 2009.

(51) Int. Cl. H04N 7/16; H04H 20/71; H04W 72/04

(52) U.S. Cl. 725/62; 370/312; 370/329

(57) ABSTRACT

The present invention provides a system and method for optimizing utility in a wireless data system. A connection is first established with a plurality of receiver devices. After the connection has been established, feedback is received from the receiver devices at periodic intervals, wherein the feedback includes channel quality information. A map is computed for each of a plurality of modulation and coding schemes (MCSs) using the received feedback, wherein the map associated with each MCS reflects the set of receiver devices capable of receiving that particular MCS. Once the MCSs have been mapped, one of the MCSs is assigned to each of a plurality of variable-sized layers of at least one video session for optimizing total system utility. If the wireless system has multiple sessions, resources are also allocated among the different sessions in a manner which further optimizes system utility.

### RELATED APPLICATION INFORMATION

This application claims priority to provisional application Ser. No. 61/169,870 filed on Apr. 16, 2009 and provisional application Ser. No. 61/239,854 filed on Sep. 4, 2009, both of which are incorporated herein by reference.

### BACKGROUND

1. Technical Field

The present invention relates to optimizing utility in broadband wireless systems, and more particularly, to allocating resources and assigning modulation and coding schemes to a scalable video multicast in wireless data systems.

2. Description of the Related Art

Next generation cellular wireless networks (i.e. 4G) are expected to deliver a much higher spectrum efficiency and bandwidth. International Telecommunication Union (ITU) requires that a 4G technology should provide a peak data rate of 100 Mbps for high mobility applications and 1 Gbps for low mobility applications. Consequently, 4G networks can provide real-time video services, including internet protocol television (IPTV) services, live video streaming, and online telecast of sports.

Nevertheless, due to the fact that the wireless spectrum is shared by many users and that each streaming video service may have very large bandwidth and stringent delay requirements, efficient resource allocation is still necessity in such a network. When multiple users attempt to access the same video content simultaneously (e.g., during a live sport or entertainment event), wireless multicast provides an efficient mechanism to support such services because of the shared nature of the wireless medium.

In nearly all wireless networks, a transmitter (i.e., the base stations in the video streaming services) can choose a modulation and coding scheme (MCS) based on the channel quality and the device capability at the receivers. An issue with modulation and coding schemes in prior art wireless multicast services is that, when multiple receivers experience heterogeneous channel conditions (e.g., due to their distance to the cellular towers or their locations), a robust modulation and coding scheme that is receivable by all wireless clients in the multicast group is normally employed to accommodate all receivers. Although scalable video coding (SVC) helps to rectify this problem in some respect, problems still exist with regard to allocating radio resources and assigning modulation and coding schemes.

### SUMMARY

In accordance with the present principles, a method is provided for optimizing utility in a wireless data system. According to this method, a connection is first established with a plurality of receiver devices. After the connection has been established, feedback is received from the receiver devices at periodic intervals, wherein the feedback includes channel quality information. A map is computed for each of a plurality of modulation and coding schemes (MCSs) using the received feedback, wherein the map associated with each MCS reflects the set of receiver devices capable of receiving that particular MCS. Once the MCSs have been mapped, one of the MCSs is assigned to each of a plurality of variable-sized layers of at least one video session with the aim of optimizing total system utility.

In accordance with the present principles, a system is also provided. The system contains a session negotiation unit for establishing a connection with a plurality of receiver devices and a channel feedback unit for receiving feedback from each of the plurality of receiver devices at periodic intervals, wherein the feedback includes channel quality information. In addition, the system includes a resource allocation unit configured to compute a map for each of a plurality of modulation and coding schemes using the received feedback, wherein the map associated with each modulation and coding scheme reflects the set of receiver devices capable of receiving that particular MCS. The system is also configured to assign an MCS to each of a plurality of variable-sized layers of at least one video session with the aim of optimizing total system utility.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating an exemplary multi-carrier wireless system for use with the present principles.

FIG. 2 is a block/flow diagram illustrating a method for optimizing utility in a wireless system with a single video session.

FIG. 3 is a block/flow diagram illustrating the intra-session MCS assignment scheme taking place in block 22 in FIG. 2.

FIG. 4 is a block/flow diagram illustrating an alternative intra-session MCS assignment scheme which can be used to optimize utility in a wireless system with multiple video sessions.

FIG. 5 is a block/flow diagram illustrating the two-step method for optimizing utility in a wireless system with multiple video sessions.

FIG. 6 is a block/flow diagram illustrating an application of the inter-session resource allocation scheme in block 53 of FIG. 5.

### DETAILED DESCRIPTION OF PREFERRED EMBODIMENTS

The description provided herein is directed to utility optimization in wireless systems with scalable video encoding. As explained in further detail below, the present principles provide both a single-session scheme for optimizing utility in a wireless system with a single video session, and a multi-session scheme for optimizing utility in a wireless system with a plurality of sessions.

To maximize system utility in the single-session scenario, a connection is first established between a base station and a plurality of receiver devices which can potentially receive the video session. At each frame, the base station receives channel state information from the connected receiver devices which includes the average signal-to-interference-and-noise ratio (SINR). Using this information, the base station is able to map each MCS to the set of receiver devices which can receive that MCS. Then, the base station uses an intra-session MCS assignment scheme to assign the appropriate MCS to each layer of the video session in such a way that maximizes utility of users. The intra-session MCS assignment scheme uses dynamic programming to assign a MCS to each layer of the video session such that total system utility of all users is maximized. After a MCS has been assigned to each layer of the video session, a multicast data transmission is scheduled for the video session.

The present principles also provide a method for optimizing utility in a multi-session scenario. More specifically, after connections have been setup and MCS mapping is complete, the above-mentioned intra-session MCS assignment method can be used to assign a MCS to each layer of each video session in the system. However, unlike in the single session scenario, the allocation of resources among the multiple video sessions should also be considered in the multi-session scenario. Therefore, after the appropriate MCSs have been assigned to the layers of each video session, an inter-session resource allocation scheme is used to allocate resources among the multiple video sessions. Like the intra-session MCS assignment scheme, the inter-session resource allocation aims at optimizing system utility. By combining the intra-session MCS assignment scheme with the inter-session resource allocation scheme, a two-step dynamic programming scheme is provided which maximizes the utility of all receiver devices in a wireless system.

Three particular points should be noted regarding the schemes described herein. First, the utility function provided is quite general. It can be both user-dependent and session-dependent and it only needs to be non-negative and non-decreasing with respect to the received data rate. Second, it is not required that all video layers have equal length. This allows for more flexibility at the video encoding process. Finally, it is not required that the base layer be received by all wireless clients. An advantage of such a choice is that it can provide an automatic admission control at both the session level and the user level. For example, if accepting a new session or a new user's request may dramatically reduce the utilities of other existing users, it is probably better not to accept the new session or the new user. Moreover, if it is required to accommodate all users with at least the base layers, the proposed algorithms can be applied on the enhancement layers after allocating slots for the base layers of all multicast sessions.

Embodiments described herein may be entirely hardware, entirely software or they may include both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

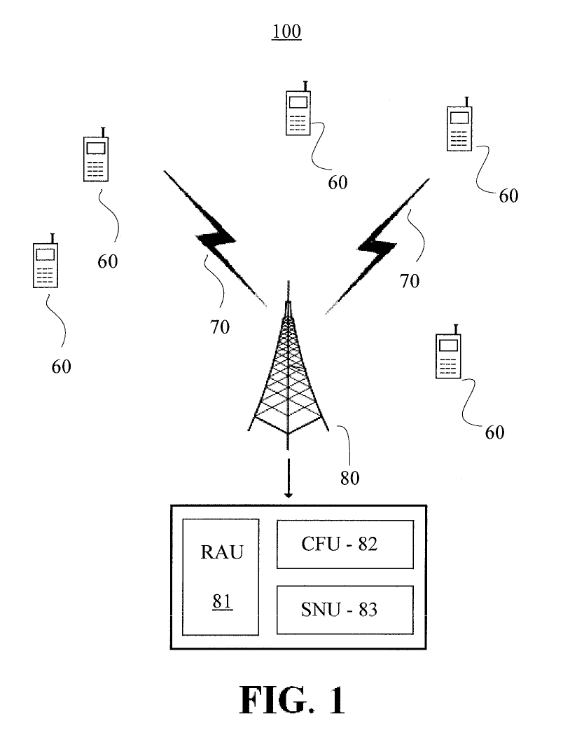

Referring now in detail to the figures in which like numerals represent the same or similar elements and initially to FIG. 1, an architecture of an exemplary multi-carrier wireless system 100 is illustratively shown. A transmitter or base station 80 is in signal communication 70 with a number of different mobile users or receiver devices 60, including laptop devices, cell phones, and/or other transceiver devices. The base station can send various sorts of data and can provide a wide range of services to receiver devices 60, including data and services involving scalable video multicasts.

As can be seen in FIG. 1, base station 80 should include at least three components: (1) a multicast resource allocation unit (RAU) 81; (2) a channel feedback unit (CFU) 82; and (3) a session negotiation unit (SNU) 83. Each of these components is described below.

When a mobile user 60 is interested in joining a multicast session or would like to open a new video session, the user sends a request to the base station 80. Upon receiving the request, the session negotiation unit 83 establishes a new session for the user or allows a user to join an existing session. The session negotiation unit 83 then updates the collection of sessions as well as the set of users in each session. Ideally, the mobile user should include its utility as a function of the received rate as well as its channel SINR in the request. The utility function can be simplified. For example, if the base station and the user have agreed that the utility function is the weighted peak signal-to-noise ratio (PSNR) of the video clip, the user only needs to send its weight, which can reflect how much the user is willing to pay for each unit of PSNR values the user receives. In this case, the objective of the base station is to maximize the total profit it can make.

When a mobile user 60 determines to leave a multicast session, the user sends an exit request to base station 80. Upon receiving the exit request, the request is forwarded to the session negotiation unit 83 which terminates the session for that user. Accepting a user's exit request also requires the session negotiation unit 83 to update its collection of sessions as well as the set of users in each session. It should be noted that whenever the collection of sessions or the set of users in each session is updated (whether such updating is done in response to a user creating a new session, joining an existing session, or exiting a session), the base station should re-run the optimization scheme to ensure that total utility is maximized in the system. Of course, such updating can be deferred at the cost of some performance loss.

After a user either joins an existing session or requests a new session, the user should periodically report its channel quality to the base station. This channel quality information will be received by the channel feedback unit 82 at the base station. The channel quality information may comprise the user's SINR value or can reflect the highest MCS the user can correctly receive. When the base station obtains such information from all users, the resource allocation unit 81 constructs a mapping from each MCS m to the set Nₘ of users that can receive MCS m. When a change in the SINR of some users leads to the change of any set Nₘ, the base station should once again update the collection of sessions and/or the set of users in each session and re-run the multicast resource allocation algorithm. Once again, this updating can be deferred at the cost of some performance loss.

Upon receiving utility and channel quality information from each user, the resource allocation unit 81 determines the resource allocation as well as the MCS selection for each video layer, with the purpose of optimizing the system utility. As explained in further detail below, the system utility is the sum of the session utilities. Therefore, the problem of optimizing utility will depend upon whether the optimization scheme is being applied to a system with a single video session or a system with multiple video sessions.

In the multi-session scenario, the problem can be decomposed into two sub-problems: intra-session and inter-session resource allocation. For the intra-session resource allocation, dynamic programming is used to assign a modulation and coding scheme for each layer in a session under any given resource constraint t (t=0, 1, . . . , T). For the inter-session allocation, dynamic programming is used to allocate resources among video sessions using the results obtained from the intra-session method. Both algorithms find the optimal solution but have pseudo-polynomial complexity.

In the alternate single-session scenario, the problem of inter-session resource allocation is irrelevant since it is not necessary to allocate resources among a plurality of sessions. Hence, in this scenario, only the problem of intra-session resource allocation applies.

Now that a description of the above-described system architecture and protocol has been provided with reference to FIG. 1, the optimization methods will be described in further detail below.

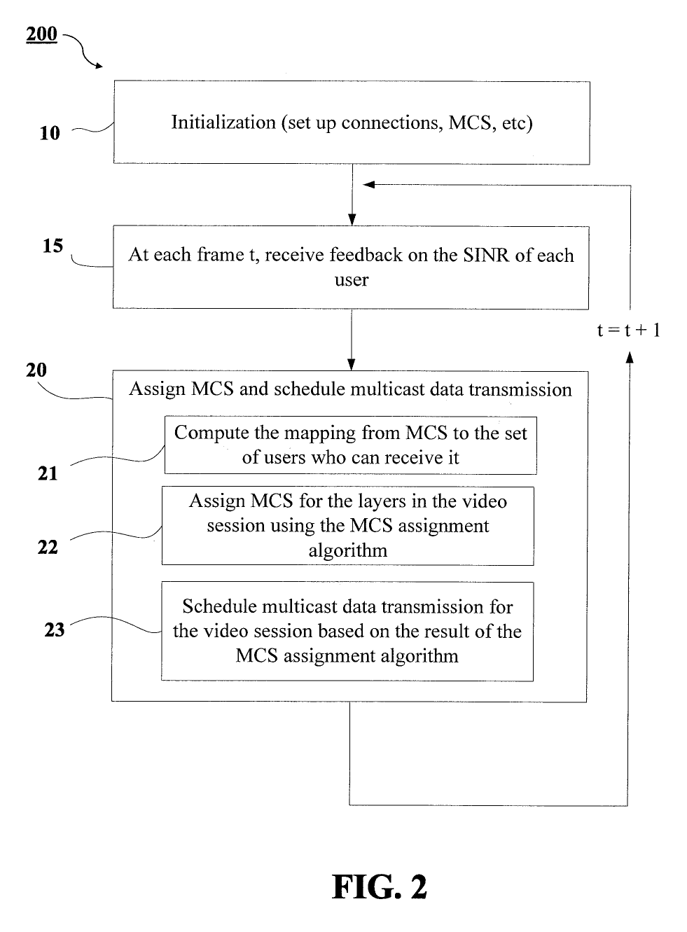

Referring to FIG. 2, a block/flow diagram 200 illustrates a method for optimizing the utility of all users in a system with a single video session. Initially, connections and multicast video sessions are setup between the receiver devices 60 and the base station 80 in block 10. After connections have been initialized, the base station 80 continuously receives channel state information at every frame from the receiver devices (block 15). The channel state information sent to the base station may include the average SINR for each receiver device or information indicating the highest MCS receivable by each receiver device. In block 20, an MCS is assigned to each layer of the video session and the video session is scheduled for a multicast data transmission. The particular manner in which this is accomplished is illustrated by blocks 21, 22 and 23.

As shown in block 21, each MCS is mapped to the set of users that are able to receive that particular MCS. The mapping of each MCS can be computed using the channel state information (e.g., SINR information for each receiver device) being received by the base station at each frame. Based on the MCS mapping, an optimal MCS is assigned to each layer of the video session such that system utility is maximized (block 22). To select the optimal MCS for each layer, an intra-session MCS assignment algorithm (discussed in further detail below) is applied. Finally, in block 23, a multicast data transmission is scheduled for the video session.

Application of the above-described method will now be illustrated in further detail. A description of the problem is provided first. After the problem has been described, it is explained how a single-session MCS assignment scheme can be used to solve this problem. For convenience of the readers, Table 1 summarizes the notations used below.

TABLE 1
Summary of Notations

| | |
|---|---|
| T | Number of slots in a frame |
| M | Number of possible MCSs |
| S | Number of video sessions |
| J | Number of users |
| L | Number of layers in a video session |
| Rₘ | Data rate of a single slot using MCS m |
| λₗ | Required video rate of the lth layer |
| τ_{l,m} | Number of slots required for transmitting the lth layer using |
| | MCS m |
| N | Set of users in the system |
| Nₘ | Set of users who can only decode MCS up to m |
| \hat{N}ₘ | Set of users who can successfully receive MCS m |
| Uⱼ(r) | Utility of user j with data rate r |
| μ_{j,l} | Utility of user j who receives l valid layers |
| M(l) | The MCS assigned for layer l in a solution |
| Γ(m) | The valid number of layers that the users in set Nₘ can receive in a |
| | solution |
| T(Φ) | The total slots consumption in solution Φ |

A “slot” is used as the minimum allocable resource unit in the system, where a slot can refer to an allocation unit in the time domain, frequency domain, or in the joint space of time domain and frequency domain. Assume there are T slots in a frame available for multicast video streaming. The possible modulation and coding schemes (MCS) are m=1, . . . , M (for example, MCS m=1 represents QPSK-1/2, and so on). Rₘ is the data rate provided by a single slot with MCS m. A higher MCS index indicates a higher data rate. N is the set of users in the system. \hat{N}ₘ is the set of users who can decode MCS m, while Nₘ is the set of users who can decode MCS up to in but not in+1. As the user who can decode MCS m can also decode all the MCS lower than m, we can get \hat{N}ₘ=U_{m′=m}^{M}N_{m′}. The scalable video session is composed of L layers. The data rate of the layer l is λ and if it is modulated with MCS m, it requires τ_{l,m}=┌λₗ/Rₘ┐ slots.

Assume that layer l is transmitted with MCS_{M(l)} in a solution, and if l is not transmitted, then set M(l)=∞, R_{∞}=∞ and N_{∞}=Ø. Then the system constraint can be expressed as

Σ_{τ=1}^{L}τ_{l,M(l)}≦T (1)

For the scalable video sequence, a received layer can be used to refine the video quality only when the user has received all the lower layers. In such a case, the received layer is said to be “valid” for the user. Denote Γ(m) as the number of valid layers for the users in set Nₘ. Since Γ(m) is the maximum number of continuous layers which are modulated with MCS 1 to m starting from the base layer, i.e.,

Γ(m)=max{l,0<M(l′)≦m, for all l′ε{1, 2 . . . , l}, 1≦l≦L}, then the received rate for a user j in set Nₘ can be expressed as rⱼ=Σₗ₌₁^{Γ(m)}λ₁.

As mentioned earlier, the utility of user j is defined to be a generic function of its received rate rⱼ, denoted as Uⱼ(rⱼ). This utility function can be an arbitrary non-decreasing non-negative function which is not only user dependent but also session dependent when applied in the scenario of multiple video sessions. Denote μ_{j,l} as the utility of user j when the layers 1 to l are correctly received, i.e., μ_{j,l}==UⱼΣ_{l′=1}¹λ_{l′}. The system utility U is defined as the sum of the utility of all the users, then we have

U=Σ_{jεN}Uⱼ(rⱼ)=Σₘ₌₁^{M}Σ_{jεN}_{ₘ}μ_{j,Γ(m)} (2)

The objective is to find out the optimal MCS assignment strategy which can maximize the total system utility U in the constraint of Equation (1). In other words, the values of all M(l) for 1≦l≦L must be determined, in order to

Maximize U=Σₘ₌₁^{M}Σ_{jεN}_{ₘ}μ_{j,Γ(m)} subject to Equation (1). (3)

Equation (3) represents the problem which is to be solved. In order to solve the problem in Equation (3), two intra-session MCS assignment algorithms are proposed.

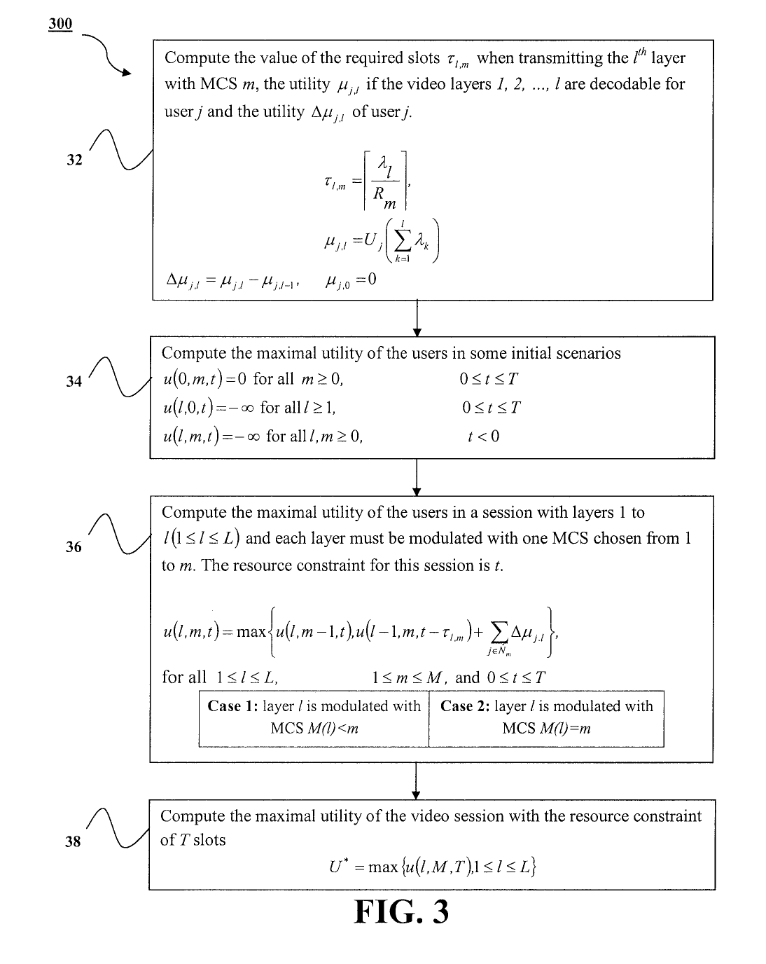

The first intra-session algorithm is described in FIG. 3 and is based on the following lemma which is assumed to be true.

Lemma 1: If the jth layer of a multicast session is modulated with MCS m, the (j+1)th layer is either not transmitted or is modulated with MCS m′≧m.

The algorithm has a complexity of O(LJ+LMT), where J is the number of users, L is the number of video layers, M is the number of Modulation and Coding Schemes (MCS), and T is the maximum number of available resource units (e.g., slots). A selectable uniform utility function is used for each user. Any non-negative and non-decreasing function with respect to the received data rate can be adopted.

Consider a scenario of a video session with layers 1˜l and we have t slots to transmit this session. Each layer must be modulated with one MCS chosen from 1˜m. Denote an auxiliary function u(l,m,t) to be the maximal utility the users can achieve with this session. Note that if there are not enough slots to modulate all the layers, u(l,m,t) will be set to −∞. The procedure of this algorithm is shown in FIG. 3.

Referring to FIG. 3, a block/flow diagram 300 is shown illustrating the MCS assignment scheme taking place in block 22 of FIG. 2. In block 32, the values for τ_{l,m} and μ_{j,l} are computed, where τ_{l,m} represents the number of slots required for transmitting the lth layer using MCS m and represents the utility of user j who receivers l valid layers. In block 34, the maximal utility of the users in some initial scenarios is computed. That is, the maximal utility is computed when l=0, m=0 and t<−0.

Next, in block 36, the maximal utility of the users in a session is computed with layers 1 to l (1≦l≦L) and each layer must be modulated with one MCS chosen from 1 to m. The resource constraint for this session is t. In the scenario of u(l,m,t), layer l must be modulated with one MCS chosen from 1 to m, so the optimal solution specified by u(l,m,t) has two possible cases according to the MCS assigned for layer l, as illustrated in block 36. Case 1 represents the first possible case. In this case, the l^{th} layer should be modulated with MCS 1 to m−1. Therefore, the total utility is u(l,m,t)=u(l,m−1,t). Alternatively, case 2 represents the case where layer l is modulated with MCS M(l)=m. In this case, the utility for layer l is Σ_{jε\hat{N}}_{ₘ}Δμ_{j,l}, and the resources left for the layers below l is t−τ_{l,m}. Thus, u(l,m,t)=u(l−1,m,t−τ_{l,m})+Σ_{jε\hat{N}}_{ₘ}Δμ_{j,l} is the uniform equation for computing u(l,m,t) in this case. According to its definition, u(l,m,t) should be the maximum of the two cases. Thus, either case 1 or case 2 is selected in block 36 depending upon which provides the greater utility.

Finally, in block 38, the maximal utility of the video session with the resource constraint of T slots is computed. Using the above-described procedure, an optimal MCS can be assigned to each layer of a video session such that the utility of all receiver devices is maximized.

If the first intra-session MCS assignment algorithm described above is used in conjunction with the inter-session resource allocation algorithm in the multi-session context, an additional computation would be necessary which is not shown either in FIG. 2 or 3. More specifically, in this case, it would also necessary to compute the value of ũ(t)=max (u(l,M,t), 1≦l≦L) for all 0≦t≦T, which is the maximum total utility for a single session with t available slots. This additional computation would then be used by the inter-session resource allocation scheme in a manner which is described in further detail below.

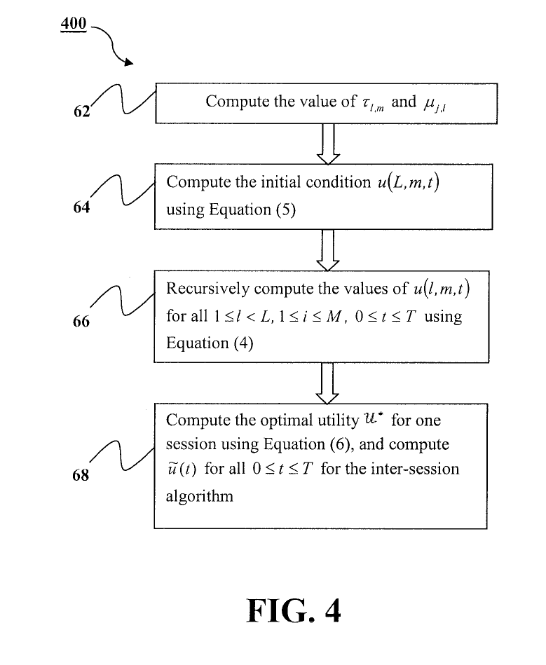

The second intra-session algorithm will now be described with reference to FIG. 4. For application of this algorithm, a utility function u(l,m,t) is defined to be the maximal utility of the layers from l to the top layer L under the resource constraint t, and the MCS for layer l is m. This algorithm is based on Lemma 1 (described above) and Lemma 2, both of which are assumed to be true.

Lemma 2: The value of u (l,m,t) depends only on the MCS assignment of the video layers higher than l.

In applying the second intra-session algorithm, the values of u(l,m,t) are recursively computed for the top layer L to the base layer. The recursion for u(l,m,t) is as

u(l,m,t)=max(Σ_{jεN}_{ₘ}μ_{j,l,}max_{m′εQ(l,m,t)}u′(l,m,m′,t)) (4)

where u′(l,m,m′,t)=u(l+1,m′,t−τ_{l+1,m′})+Σ_{jεN}_{ₘ}_{-N}_{_{m′}}μ_{j,l}Q(l,m,t)=(m′:m≦m′≦M,τ_{l+1,m′}≦t)

Given the initial condition:

u(L,m,t)=Σ_{jεN}_{ₘ}μ_{j,L} for all 1≦i≦M, 0≦t≦T (5)

the optimal utility for one video session can be recursively computed:

u*=max{u(1,m,T=τ_{l,m}):1≦m≦M, τ_{l,m}≦T}, (6)

For use with the inter-session resource allocation algorithm, it is also necessary to compute the value of ũ(t)=max{u(1,m,t−τ_{1,m}): 1≦m≦M, τ_{1,m}≦t} for all 0≦t≦T, which is the maximum total utility for a single session with t available slots.

The complexity of this second intra-session MCS assignment algorithm in the multi-session context is now provided. The values of μ_{j,l} and Σ_{jεN m}μ_{j,l} can be precomputed together before the recursion procedure in O(JL), where J is the number of users in this session. For the worst-case of the recursion procedure, we should compute the values of u(l,m,t) for all 1≦l≦L, 1≦m≦M, 1≦t≦T, and every step of the recursion has a maximum complexity of O(M) so the worst-case complexity of the recursion is O(LM²T). Therefore, the complexity for this intra-session algorithm is O(JL+LM²T)=O(JL+LM²T).

Referring to FIG. 4, a block/flow diagram 400 is provided with a concise summary of the computation described above using the intra-session algorithm. Initially, in block 62, the value of τ_{l,m} and μ_{j,l} is computed. Then, the initial position u(L,m,t) is computed using Equation (5) provided up above (block 64). Next, in block 66, Equation (4) is used to recursively compute the values of u(l,m,t) for all 1≦l<L, 1≦i≦M, 0≦t≦T. And finally, in block 68, the optimal utility u* is computed for one session using Equation (6). If the above-described intra-session algorithm is used in the multi-session context, the value of ũ(t) for all 0≦t≦T must also be computed.

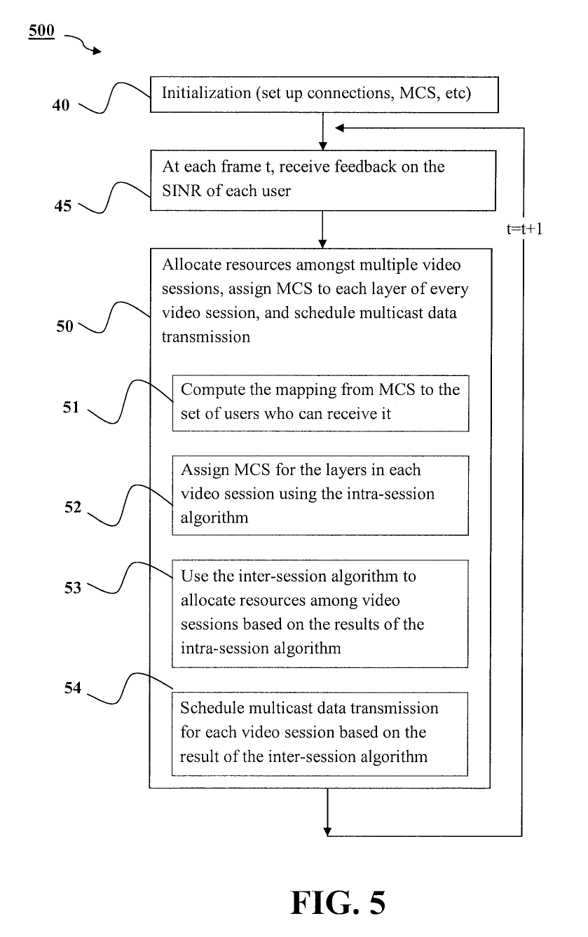

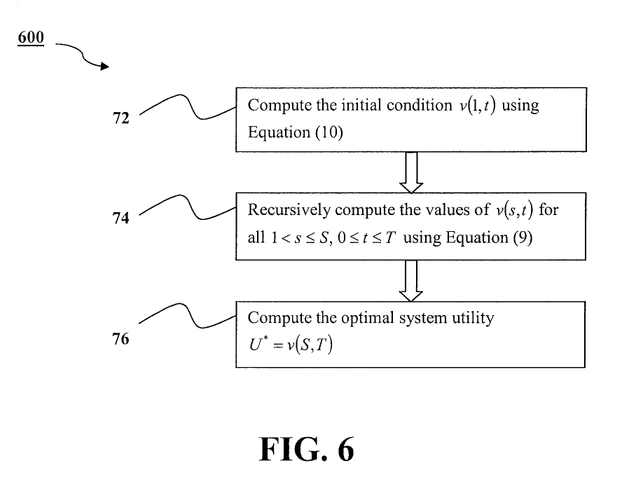

Now that a description of the two different intra-session MCS assignment schemes has been provided, it will be explained how these schemes can be combined with an inter-session resource allocation scheme to provide a two-step dynamic programming scheme for optimizing utility in a system with multiple video sessions. This two-step dynamic programming scheme is described with reference to FIGS. 5 and 6.

Referring to FIG. 5, a block/flow diagram 500 discloses a method for optimizing utility in a system with a plurality of video sessions. In block 40, connections are initialized between base station 80 and a plurality of receiver devices 60. Multicast video sessions are also established in this block. After connections have been initialized, the base station receives feedback from the receiver devices at each frame in block 45. The feedback may include information regarding the SINR for each user, or information indicating the highest MCS receivable by the user. Referring to block 50, both the intra-session MCS assignment scheme and the inter-session resource allocation scheme are applied to optimize utility. After each layer has been assigned an MCS and resources have been allocated among the video sessions, each video session is scheduled for a multicast data transmission.

Blocks 51-54 explains the particulars of block 50 in further detail. First, in block 51, the mapping is computed from each MCS to the set of users who can receive that MCS. Next, in block 52, the intra-session MCS assignment algorithm (discussed above) can be applied to each video session such that each layer of each session is assigned a MCS. (As briefly mentioned above and explained in further detail below, the intra-session MCS assignment algorithm is applied in a slightly different manner in this multi-session scenario than it had been applied above in the single-session scenario.) Based on the results of the intra-session algorithm, resources are then allocated among the multiple video sessions such that the utility of all users is maximized (block 53). To allocate resources in such a manner, an inter-session resource allocation algorithm (discussed in further detail below) is applied. The results of the inter-session algorithm are then used to schedule a multicast data transmission for each video session in block 54.

A more detailed explanation of the above-described method will now be provided in further detail. The explanation of the problem is first provided, and then it is explained how two-step scheme can be used to solve this problem. For convenience of the readers, a Table 2 provides a summary of the notations used below. It should be noted that the notations used in this example are similar to the notations used in the first example provided above. However, many of the notations used in this example include an additional index to account for the fact that there are multiple sessions in this example.

TABLE 2
Summary of Notations

| | |
|---|---|
| T | Number of slots in a frame |
| M | Number of possible MCSs |
| S | Number of video sessions |
| J | Number of users |
| L^{[s]} | Number of layers for video session a |
| Mⱼ | The maximum MCS that user j can receive |
| Rₘ | Data rate of a single slot using MCS m |
| λₗ^{[s]} | Required video rate of the l^{th} layer of session s |
| N^{[s]} | Set of users in video session s |
| Nₘ^{[s]} | Set of users in video session s who can successfully |
| | receive MCS m |
| Uₗ^{[s]}(r) | Utility of user j if data rate r can be received |
| u^{[s]}(l, m, t) | Maximum utility of session s, given that the total |
| | available slots for this session is t |
| μ_{j,l}^{[s]} | Utility of user j of session s if layers up to l are |
| | received |
| τ_{l,m}^{[s]} | Number of slots required for transmitting the l^{th} layer |
| | in video session s using MCS m |

Consider the following problem formulation. It once again assumed that there are T slots in a frame available for multicast video streaming, where a slot can refer to a minimum allocation unit in the time domain, frequency domain, or in the joint space of time domain and frequency domain. S is the number of multicast sessions. N^{[s]} is the set of users in session s. The possible modulation and coding schemes (MCS) are m=1, . . . , M (for example, MCS m=1 represents QPSK-1/2, and so on). Rₘ is the data rate provided by a single slot with MCS m. A higher MCS index indicates a higher data rate. Mⱼ is the maximum MCS that can be received by user j. A video session s has L^{[s]} layers. The data rate of layer l of video session s is λₗ^{[s]} and if it is modulated with MCS m, it requires τ_{l,m}^{[s]}=┌λₗ^{[s]}/Rₘ┐ slots. Denote X_{l,m}^{[s]} as an indicator function that is 1 if layer l of session s is modulated with MCS m and 0 otherwise.

The rate of user j in session s is rⱼ^{[s]}, which can change with different assignment of the modulation coding schemes for the video layers. Denote Mⱼ the maximum MCS that can be received by user j and X_{l,m}^{[s]} si as an indicator function that is 1 if layer l of session s is modulated with MCS m and 0 otherwise. Then, the data rate of user j for session s is:

rⱼ^{[s]}=Σₗ₌₁^{L}^{^{[s]}}Σₘ₌₁^{M}^{ⱼ}λₗ^{[s]}X_{l,m}^{[s]} (7)

A generic utility function Uⱼ^{[s]}(rⱼ^{[s]}) is used for user j in session s. The function can be an arbitrary non-decreasing non-negative function that can be both session dependent and user dependent.

Our objective is to maximize the sum of all the user utilities in all video sessions subject to the constraint that T slots are available for the downlink multicast in the system, as shown below.

MaximizeΣₛ₌₁^{S}Σ_{jεN}_{ₛ}Uⱼ^{[s]}(rⱼ^{[s]}) (8)

where rⱼ^{[s]} is defined in Equation (7), subject to the constraints

Σₘ₌₁^{M}X_{l,m}^{[s]}≦1, l=1, . . . L and Σₛ₌₁^{S}Σₘ₌₁^{M}Σᵢ₋₁^{L}X_{l,m}^{[s]}τ_{l,m}^{[s]}≦T

where the first set of constraints states that for a given video layer l, it can be modulated and coded with at most one MCS, and the second set of constraints dictates that the total number of available slots for all video sessions is T. Note that a layer l may not be modulated with any MCS, i.e. Σₘ₌₁^{M}X_{l,m}^{[s]}=0. In that case, layer l is not transmitted.

This is an integer programming problem where the variables to be optimized are X_{l,m}^{[s]}. In other words, we need to determine, for each layer of each session, whether it needs to be transmitted, and if so, what modulation and coding scheme should be used for that layer.

To compute the maximum utility, a two step-dynamic programming scheme is used. In the first step, one of the intra-session MCS assignment schemes (which were explained above) is used to assign a MCS to each layer of each video session. In the second step, the inter-session resource allocation scheme is used to allocate resources among the multiple sessions. Both the intra-session and inter-session schemes aim at maximizing the total utility of all users in the system. The two step-dynamic programming scheme uses a pseudo-polynomial algorithm based on dynamic programming for both single-session and multi-session services. The complexity of the algorithm for the multi-session services is, 0(S L̅\tilde{J}+S L̅M²T+ST²) where S is the number of sessions and L̅ is the average number of video layers of all sessions, \tilde{J} is the maximum number of users in a session, M is the number of Modulation and Coding Schemes (MCS), and T is the maximum number of available resource units (e.g., slots). The algorithm is pseudo-polynomial because the number of resource units T may be exponential in the number of users and the layers. In practice, T is often quite limited. Therefore, the problem is optimally solved with acceptable overhead in most practical systems.

The objective of the inter-session algorithm is to maximize the system utility in Equation (8) by optimally allocating resources for all the layers among all the video sessions. Let T(s) denote the resources allocated to video session s, 0≦T(s)≦T. A two-step decomposition technique is used to optimize the system-wide resource allocation based on the results of intra-session algorithm.

Define ũ^{[s]}(t) as the maximum utility for session s if t slots are allocated to the session. Although it was not necessary in the single session scenario, the value of ũ^{[s]}(t) for all 0≦t≦T should also be computed here. The results of ũ^{[s]}(t) for all 0≦t≦T are then used by the inter-session algorithm as explained below in further detail.

The inter-session utility optimization problem in Equation (8) can be equivalently formulated as

$$Maximize U = {\sum }_{s = 1}^{S} {\tilde{u}}^{[ s ]} ( T ( s ) ) subject to {\sum }_{s = 1}^{S} T ( s ) \leq T$$

We can also use a dynamic programming algorithm to solve this sub-problem.

First, an auxiliary function v(s,t) is defined to be the maximum utility of the video sessions from 1 to s with the total available resources t left for the sessions from 1 to s. The objective is to recursively compute v(S,T) which is the solution for this sub-problem and also for the optimization problem in Equation (8).

Consider a generic scenario of v(s,t) (1≦s≦S) in the recursive procedure. All the values of v(s′,t) for all 1≦s′≦s and 0≦t≦T were computed in the past procedure. It is assumed that the utility of session s depends only on its resource constraint and is independent of other sessions. Further assume that the resource allocated to session s is t′(0≦t′≦t) then the maximum utility of sessions from 1 to j should be ũ^{[s]}(t′)+v(s−1,t−t′). Therefore, in order to obtain the value of v(s,t), we only need to check all the possible values of t′. Then we can get the following recursion for v(s,t).

v(s,t)=max_{t′=0}^{t}((ũ^{[s]}(t′)+v(s−1,t−t′))) (9)

The recursion is started from the scenario of v(1,t), in which there is only one video session under the resource constraint t for the enhancement layers. This initial condition can be computed based on the results of the intra-session algorithm:

v(1,t)=\tilde{μ}^{[1]}(t) for all 0≦t≦T, (10)

After the recursive procedure, the maximum system utility U*=v(S,T) can be determined for the optimization problem in Equation (8).

Referring to FIG. 6, a block/flow diagram 600 provides a concise summary of the above-discussed computations associated with the inter-session resource allocation scheme. In block 72, the initial condition v(1,t) is computed using Equation (10). The initial condition represents the situation where there is only one session under resource constraint t. Next, in block 74, Equation (9) is used to recursively compute the values of v(s,t) for all 1<s≦S, 0≦t≦T. After the recursive procedure has computed these values, the optimal system utility U*=v(S,T) can then be computed (block 76).

The complexity of this inter-session resource allocation algorithm is now discussed. The values of ũ^{[s]}(t) for all 1≦S, 1≦t≦T can be pre-computed using the intra-session algorithm and the complexity is O└Σₛ₌₁^{S}(L^{[s]}(J+M²T))┘. Let L̅ denote the average number of layers in the sessions and \tilde{J} denote the maximum number of users in a session. The complexity becomes O(S L̅(\tilde{J}+M²T)). For the worst-case of the recursion procedure, compute the values of v(s,t) for all 1≦s≦S, 1≦t≦T, and every step of the recursion has a maximum complexity of O(T). So the worst-case complexity of the recursion is O(ST²). Therefore, the complexity for the joint intra- and inter-session algorithm is O(S L̅\tilde{J}+S L̅M²T+ST²).

The integrated algorithm is pseudo-polynomial due to the factor T In practical systems, the value of T is limited by the available physical resources in a wireless frame, and is normally bounded by a reasonable value. Therefore, the complexity is acceptable for most practical systems.

Furthermore, if T exceeds a threshold \tilde{T}, we can solve the optimization problem in Equation (8) in a very simple way. If there are enough resources for all the layers of all sessions to be transmitted using the most robust MCS (i.e., MCS 1), all users in the system achieve the highest possible video rate. As the utility function Uⱼ(rⱼ) is a monotonic non-increasing function of the received rate rⱼ, each user achieves the maximum utility and the maximum system utility is also obtained. The resource requirement for this scenario is

$$T \geq \tilde{T} = {\sum }_{s = 1}^{S} {\sum }_{l = 1}^{{L}^{[ s ]}} {τ}_{l , 1}^{[ s ]} .$$

The maximum utility for the system in this case is

$${U}^{*} = {\sum }_{s = 1}^{S} {\sum }_{j ∈ {N}^{[ s ]}}^{ } {μ}_{j , {L}^{[ s ]}} \qquad$$

Having described preferred embodiments of a system and method for optimizing utility in broadband wireless systems (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for optimizing utility in a wireless data system, the method steps comprising:
establishing a connection with a plurality of receiver devices;
receiving feedback from the receiver devices at periodic intervals, wherein the feedback includes channel quality information;
computing a map of each of a plurality of modulation and coding schemes (MCSs) using the received feedback, wherein the map associated with each MCS reflects a set of receiver devices capable of receiving that particular MCS; and
assigning one of the MCSs to each of a plurality of variable-sized layers of at least one video session for optimizing total system utility.

2. The method of claim 1, wherein the at least one video session comprises a plurality of video sessions.

3. The method of claim 2, further comprising allocating resources among the plurality of video sessions for optimizing total system utility.

4. The method of claim 1, further comprising scheduling a multicast data transmission for the at least one video session.

5. The method of claim 1, further comprising updating MCS mapping and MCS assignments upon the occurrence of a triggering event.

6. The method in claim 5, wherein the triggering event includes a determination that the channel quality of at least one receiver device has changed such that the receiver device can no longer receive a particular MCS which has been mapped to the receiver device.

7. The method in claim 5, wherein the triggering event includes a determination that a receiver device has created a new video session, joined an existing video session, or exited an existing video session.

8. The method of claim 1, wherein the channel quality information received from the receiver devices comprises signal-to-interference-and-noise ratio information or information indicating the highest receivable MCS.

9. The method of claim 1, wherein the feedback from each of the plurality of receiver devices is periodically received at each frame.

10. A system, comprising:
a session negotiation unit configured to establish a connection with a plurality of receiver devices;
a channel feedback unit configured to receive feedback from each of the plurality of receiver devices at periodic intervals, wherein the feedback includes channel quality information; and
a resource allocation unit configured to:
compute a map for each of a plurality of modulation and coding schemes (MCSs) using the received feedback, wherein the map associated with each MCS reflects the set of receiver devices capable of receiving that particular MCS; and
assign one the MCSs to each of a plurality of variable-sized layers of at least one video session for optimizing total system utility.

11. The system in claim 10, wherein the at least one video session comprises a plurality of video sessions.

12. The system of claim 11, wherein the resource allocation unit is configured to allocate resources among the plurality of video sessions.

13. The system of claim 10, further comprising a scheduler configured to schedule a multicast data transmission for the at least one video session.

14. The system of claim 10, wherein the resource allocation unit is configured to update resource allocations and MCS assignments upon the occurrence of a triggering event.

15. The system of claim 14, wherein the triggering event includes a determination that the channel quality of at least one receiver device has changed such that the receiver device can no longer receive a particular MCS which has been mapped to the receiver device.

16. The system of claim 14, wherein the triggering event includes a determination that a receiver device has created a new video session, joined an existing video session, and/or exited an existing video session.

17. The system of claim 10, wherein the channel quality information comprises either signal-to-interference-and-noise ratio information or information indicating the highest receivable MCS.

18. The system of claim 10, wherein the system further comprises at least one database for keeping track of ongoing video sessions and the set of receiver devices participating in each video session.
